(19) United States
(12) Patent Application Publication
(10) Pub. No.: US 2006/0109233 A1
(43) Pub. Date: May 25, 2006

(54) METHOD FOR IMPROVING A DISPLAY IMAGE PERFORMANCE OF A TRANSFLECTIVE LCD

(76) Inventors: Hsin-Ta Lee, Taoyuan County (TW); Yen-Hua Chen, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,123

(22) Filed: Mar. 21, 2005

(30) Foreign Application Priority Data
Nov. 23, 2004 (TW) 093136045

(51) Int. Cl. G09G 3/36

(52) U.S. Cl. 345/102

(57) ABSTRACT

A method for improving the display image performance of a transflective LCD containing a back light is disclosed. The method includes setting the LCD driving voltages in a first range when the back light unit is on, and setting the LCD driving voltages in a second range when the back light unit is off, where the second range is different from the first range.

### BACKGROUND OF INVENTION

1. Field of the Invention

The present invention relates to a method for improving the display image performance of a transflective LCD, and more particularly, to a method of adjusting the driving voltage range of an LCD for improving the display image performance of a transflective LCD.

2. Description of the Prior Art

Since the advantages of a liquid crystal display (LCD) device over a conventional CRT monitor include better portability, lower power consumption and lower radiation, the LCD device is widely used in various portable products, such as notebooks, personal data assistants (PDAs), electronic toys, etc.

In general, the driving of a liquid crystal display involves the control of the alignment of liquid crystal molecules by using a plurality of driving IC chips. When the signals of a display image is received, the driving IC chip will provide driving voltages to each transistor within each pixel for driving the liquid crystal molecules to different directions, and incident light will eventually have different levels of polarization or refraction according to the alignment of the liquid crystal molecules. By combining the physical characteristics of the liquid crystal molecules and color filters or RGB (red, green, and blue) light sources, the liquid crystal display is able to produce RGB light with different gray level, thereby generating a colorful image. Hence the determination of the driving voltage range of the entire liquid crystal display, including the on-off of the thin film transistors and the driving voltage of each gray level, ultimately becomes a critical task for the panel designers for producing a desirable color output.

The LCD device is a passive luminous device, so that a supplemental light source is usually required to generate light beams when the LCD device displays images. In general, the LCD devices can be classified into categories including reflective LCD devices, transmissive LCD devices, and transflective LCD devices. A transmissive LCD device usually has a backlight module or a backlight source for generating light beams, which pass through a liquid crystal unit and various optical elements such as polarizers, for allowing users to see images displayed by the transmissive LCD device. Additionally, a reflective LCD device includes a reflective surface (such as aluminum) therein. Light beams such as ambient light beams will enter the reflective LCD device from the front of the reflective LCD device, pass through a liquid crystal unit and various optical elements, and be reflected back by the reflective surface. Next, the reflected light beams will pass through the liquid crystal unit and the optical elements one more time such that users can see images displayed by the reflective LCD device. In addition, a transflective LCD device has characteristics of both the transmissive LCD device and the reflective LCD device. When the intensity of the ambient light beams is high enough, or the transflective LCD device requires fewer light beams to display images, the transflective LCD device will reflect ambient light beams to display images. Additionally, when the intensity of the ambient light beams is quite low, or the transflective LCD device requires more light beams to display images, a backlight module in the transflective LCD device will be switched on to generate light beams. Therefore, the transflective LCD device has an advantage of reducing power consumption of the backlight module.

Generally, reducing power consumption is a major requirement of a portable electronic product such as a mobile phone, which is equipped with an LCD device. Hence, the transflective LCD device is usually used in portable electronic devices because it has an advantage of low power consumption. Taking a mobile phone as an example, images displayed on an LCD device of the mobile phone when the mobile phone is in a standby mode include time, or messages showing missed calls. These images do not require high intensity of light beams and therefore the LCD device of the mobile phone can reflect ambient light beams to display images when the mobile phone is in a standby mode. On the other hand, when the mobile phone is in use, the backlight module of the LCD device can be switched on to generate light beams for the users to clearly see images containing numerals or characters displayed on the LCD device.

As seen from these examples, when in use, the images of the transflective LCD of portable electronic devices such as mobile phones are usually displayed under the transmissive mode, in order to produce clear images. Accordingly, most panel designers design the transflective LCD by giving priority to the transmissive mode so that users can see beautiful display images under the transmissive mode. Similarly, the setting of the driving voltages of the transflective LCD is mainly designed accordingly to the display quality under the transmissive mode. For example, the gap between the driving voltages corresponding to each gray level while tuning the gray level is minimized by setting the driving voltages of the transflective LCD for producing images with better quality. Nevertheless, the conventional method will unavoidably sacrifice the display quality of the transflective LCD under the reflective mode. Due to the fact that ambient lights are usually weaker than normal backlight sources and furthermore that the lights have to pass through optical devices and liquid crystal unit, be reflected via a reflective surface, and re-pass through the optical devices and liquid crystal unit before producing an image to the human eyes, the images produced under the reflective mode are usually dimmer and unclear. Accordingly, how to improve the display quality of a transflective LCD under the reflective mode is still an important issue that has to be researched.

### SUMMARY OF INVENTION

It is therefore an objective of the present invention to provide a method for improving the display image performance of a transflective LCD by setting different driving voltage ranges of the liquid crystal display under different operating modes.

According to the present invention, a method for improving the display image performance of a transflective liquid crystal display is disclosed, wherein the images produced by the transflective liquid crystal display are supported by a plurality of driving voltages, and the transflective liquid crystal display further comprises a backlight source for providing back light under the transmissive mode. The method comprises: setting the driving voltages in a first driving voltage range when the backlight source is on; and setting the driving voltages in a second driving voltage range when the backlight source is off, where the second driving voltage range is different from the first driving voltage range.

By using software to set the driving voltages of the reflective and transmissive modes in different driving voltage ranges, the present invention is able to create different gray levels under transmissive or reflective modes for adjusting the arrangement of the liquid crystal molecules, which will in turn increase the reflectance of the reflective mode and ensure that the image quality of the transflective LCD is well maintained under the reflective mode.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective diagram showing the method for improving the image quality of a transflective liquid crystal display according to the present invention.

FIG. 2 is a curve diagram showing the relationship between the transmittance of the liquid crystal display of FIG. 1 and the driving voltage VLC under a transmissive mode.

FIG. 3 is a curve diagram showing the relationship between the reflectance of the liquid crystal display of FIG. 1 and the driving voltage VLC under a reflective mode.

FIG. 4 is a diagram showing the operation logic of the liquid crystal display of FIG. 1.

### DETAILED DESCRIPTION

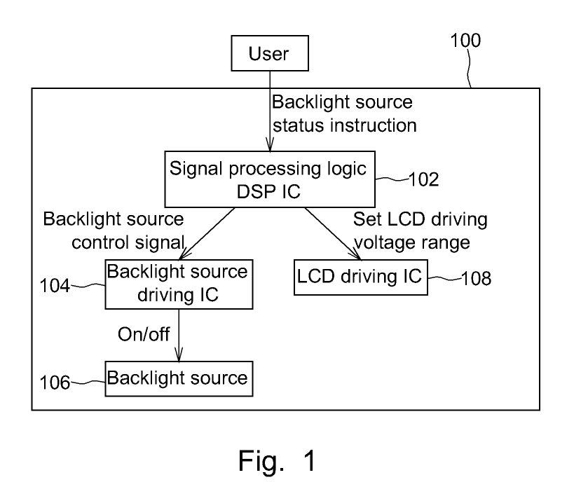

Please refer to FIG. 1. FIG. 1 is a perspective diagram showing the method for improving the display image performance of a transflective liquid crystal display according to the present invention. As shown in FIG. 1, a liquid crystal display 100 is a transflective liquid crystal that comprises a liquid crystal layer (not shown), a signal processing logic 102, a backlight source 106, at least one backlight driver integrated circuit (IC) 104, and a plurality of LCD driver ICs 108, in which the signal processing logic 102 is used for processing numerous instructions given by the users. The signal processing logic 102 of the present invention is a digital signal processing IC (DSP IC), which can be used to control the on and off function of the backlight source 106 and set the LCD driver IC 108. The backlight source 106 functions to provide light beams to the liquid crystal display 100 under the transmissive mode whereas the LCD driver IC(s) 108 function to transmit signals to the transistor of each pixel for driving the liquid crystal molecules and producing images.

When the liquid crystal display 100 is used in portable electronic products such as cellular phones, the liquid crystal display 100 will be mostly operated under the reflective or transmissive mode. For instance, when a cellular phone is in use, the liquid crystal display 100 will be set to the transmissive mode to use the backlight source 106 to produce screens with clearer images and higher intensity. On the other hand, when the cellular phone is in stand by mode, the phone will be set to a reflective mode by automatically sending an instruction to the liquid crystal display 100 to turn off the backlight source 106. Hence, the signal processing logic 102 of the present invention is used for receiving the instruction of the portable electronic product corresponding to the backlight source status. After the instruction is received, the signal processing logic 102 will output a backlight control signal to the backlight driver IC 104 for turning the backlight source 106 on and off. At the same time, the signal processing logic 102 will set the driving voltages to the LCD driver IC 108.

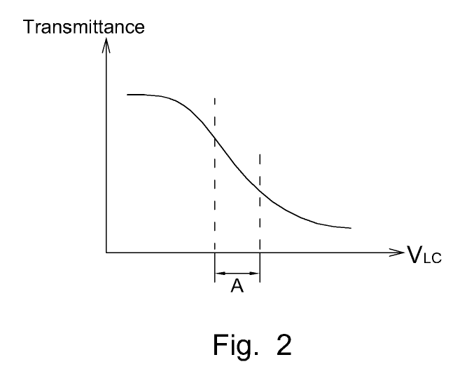

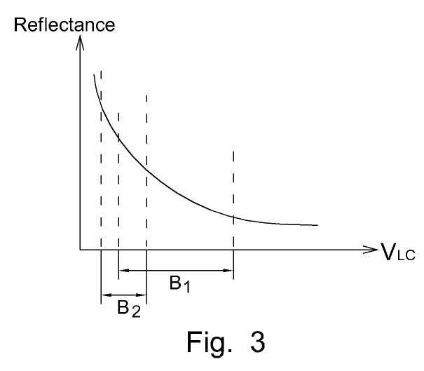

Please refer to FIG. 2 and FIG. 3. FIG. 2 is a V-T curve diagram showing the relationship between the transmittance of the liquid crystal display 100 and the driving voltage V_{LC} under a transmissive mode whereas FIG. 3 is a V-R curve diagram showing the relationship between the reflectance of the liquid crystal display 100 and the driving voltage V_{LC} under a reflective mode. Although the curve diagrams in FIG. 2 and FIG. 3 demonstrate an influence of the driving voltages on the transmittance and reflectance, the V-T or V-R curve diagram of other transflective liquid crystal displays may not be identical to the ones shown in FIG. 2 and FIG. 3.

According to the present invention, when the backlight source 106 is on, which indicates that the liquid crystal display 100 is operating under the transmissive mode, the influence of the driving voltages on the light transmittance will be equal to the result shown in FIG. 2, and the signal processing logic 102 will set the driving voltage of the liquid crystal display 100 within a first driving voltage range A. The driving voltage range can be adjusted by the users according to the demanded quality of the transmissive displays, such that the driving voltages corresponding to each gray level can be tuned to produce images with better gray level quality.

On the other hand, when the portable electronic product is in stand by mode, the signal processing logic 102 will receive a backlight source status instruction to turn off the backlight source 106. At the same time, the signal processing logic 102 will send backlight source control signals to the back light driver IC 104 to turn off the backlight source 106 and also send instructions to each LCD driver IC 108 to set the driving voltage within a second driving voltage range B₁, as shown in FIG. 3. Since the images and characters shown on the liquid crystal display 100 are not constantly viewed by the users during a stand-by situation, the setting of the second driving voltage range B₁ will be adjusted principally for producing images with higher readability, such as adjusting the voltage distribution of the second driving voltage range B₁ to be larger than the first driving voltage range A. The driving voltages of each gray level are also adjusted to have a greater value difference for producing a more rough but definite image quality.

According to another embodiment of the present invention, the setting of the driving voltages under the reflective mode is determined by the reflectance of ambient light. For instance, by setting the driving voltage within a second driving voltage range B₂, the liquid crystal display 100 will be able to produce a higher reflectance, thereby increasing the overall intensity of the display image. Moreover, in a third embodiment, the maximum value of the second driving voltage range B₂ can be set smaller than the maximum value of the first driving voltage range A for reducing the power expenditure of the electronic product.

Nevertheless, the liquid crystal display 100 of some other electronic products is generally operated under the reflective mode, and only under certain circumstances (such as when the ambient light source is insufficient) is operated under the transmissive mode. Normally, the users are able to set different driving voltage ranges according to each reflective mode (when the back light is off) or each transmissive mode (when the back light is on).

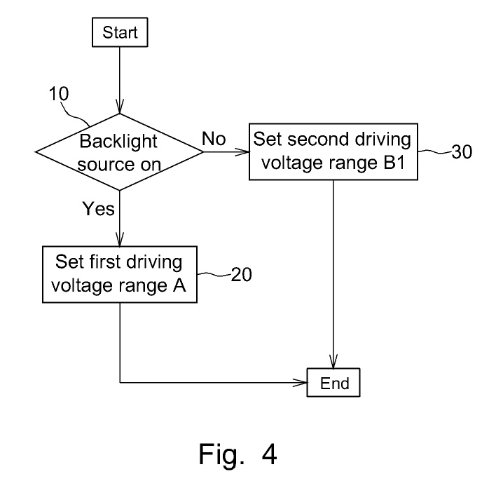

Please refer to FIG. 4. FIG. 4 is a diagram showing the operation logic of the liquid crystal display 100 of FIG. 1. First, determine whether the backlight source 106 is on, as shown in step 10. If the determination is positive, step 20 will be performed to set the driving voltage in a first driving voltage range A. Hence when the liquid crystal display 100 is in use, the liquid crystal molecules will be driven to the first driving voltage range A. If the determination is negative, step 30 will be performed to set the driving voltage in a second driving voltage range B₁ (or, in another embodiment, a second driving voltage range B₂), hence when the liquid crystal display 100 is in use, the liquid crystal molecules will be driven to the second driving voltage range B₁.

According to another embodiment of the present invention, the backlight source of the liquid crystal display can be set to half on, such that the backlight source will provide dimmer back light and work together with the ambient light. In order to maintain the image quality of the liquid crystal display when the backlight source is half on, a third driving voltage range can be set by the user, in which the third driving voltage range is different from the first driving voltage range when the back light is on, and the second driving voltage range when the back light is off.

By altering the program codes of the embedded software and using a signal processing logic, the present invention is able to control the on and off function of the backlight source and set different driving voltage ranges for improving the display quality of a transflective LCD. For example, a lookup table corresponding to the reflective mode and transmissive mode can be stored in the signal processing logic to improve the overall driving efficiency. In addition, since the signal processing logic (i.e. DSP IC) is able to control the backlight source status and the range of the driving voltages, no extra cost is needed for adding a sensor for increasing the quality of the display.

Since the driving voltages of the conventional method are fixed within a range, a special layout is generally required to raise the reflectance of lights for improving the quality of the display under the reflective mode. Under this condition, both the fabrication cost and the yield will be affected. In contrast to the conventional method, the present invention uses a software optimization method to drive the liquid crystal display according to the on-off status of the backlight source for increasing the visual effect of the display result. The present invention is also applicable to transflective LCDs that are capable of achieving both reflective and transmissive effect at the same time, thereby producing the desired image quality for the users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for improving the display image performance of a transflective liquid crystal display (LCD), wherein the images produced by the transflective liquid crystal display are supported by a plurality of driving voltages, and the transflective liquid crystal display further comprises a backlight source, the method comprising:
setting the driving voltages in a first driving voltage range when the backlight source is on; and
setting the driving voltages in a second driving voltage range when the backlight source is off, wherein the second driving voltage range is different from the first driving voltage range.

2. The method of claim 1, wherein the transflective liquid crystal display further comprises a plurality of LCD driving integrated circuits (ICs) for providing the driving voltages to the transflective liquid crystal display, and the method further comprises controlling the LCD driving ICs for setting the driving voltages.

3. The method of claim 1, wherein the transflective liquid crystal display further comprises a signal processing logic for controlling the settings of the driving voltages.

4. The method of claim 3, wherein the signal processing logic utilizes at least one set of program codes for controlling the settings of the driving voltages and the on and off function of the backlight source.

5. The method of claim 3, wherein the signal processing logic further controls the on and off function of the backlight source.

6. The method of claim 5, wherein the signal processing logic sets the driving voltages in a first driving voltage range when the signal processing logic receives an instruction to turn the backlight source on.

7. The method of claim 5, wherein the signal processing logic sets the driving voltages in a second driving voltage range when the signal processing logic receives an instruction to turn the backlight source off.

8. The method of claim 3, wherein the signal processing logic is a digital signal processing (DSP) IC.

9. The method of claim 1, wherein the first driving voltage range is set according to the gray level performance of the images produced by the transflective liquid crystal display, and the second driving voltage range is set according to the readability of the images produced by the transflective liquid crystal display.

10. The method of claim 1, wherein the second driving voltage range provides an electricity-saving function to the transflective liquid crystal display.

11. The method of claim 10, wherein the maximum value of the second driving voltage range is less than the maximum value of the first driving voltage range.

12. The method of claim 1, wherein the voltage distribution of the second driving voltage range is greater than the voltage distribution of the first driving voltage range.

13. The method of claim 1 further comprising setting the driving voltages in a third driving voltage range when the back light is half on, wherein the third driving voltage range is different from the first and second driving voltage ranges.
